(19) United States
(12) Patent Application Publication
(10) Pub. No.: US 2002/0019242 A1
(43) Pub. Date: Feb. 14, 2002

(54) Device and method for cordless transmission of telephone calls via a number of base stations to mobile dect telephones

(75) Inventor: Ronalf Kramer, Munchen (DE)

Correspondence Address: GREENBLUM & BERNSTEIN, P.L.C., 1941 ROLAND CLARKE PLACE, RESTON, VA, 20191, US

(73) Assignee: INFINEON TECHNOLOGIES AG, Munchen (DE)

(21) Appl. No.: 09/875,968

(22) Filed: Jun. 8, 2001

Related U.S. Application Data
(63) Continuation of application No. PCT/DE99/03839, filed on Dec. 1, 1999.

(30) Foreign Application Priority Data
Dec. 9, 1998 (DE) 198 56 813.4

(51) Int. Cl. H04Q 7/20

(52) U.S. Cl. 455/462; 455/465

(57) ABSTRACT

The present invention is related to a device for the radio transmission of telephone calls via several base stations which are spatially separated from mobile phones being in a DECT standard. The spatially separated base stations can be connected to the telephone network via several switching centers which are also spatially separated, whereby an additional line is then connected between the switching centers for measuring the running time between the switching centers and for synchronization.

This is a continuation of International Application No. PCT/DE99/03839, filed Dec. 1, 1999, the contents of which are expressly incorporated by reference herein in its entirety. The International Application was not published under PCT Article 21(2) in English.

The present invention relates to a device and a method for cordless transmission of telephone calls via a number of spatially separate base stations to mobile telephones in the DECT standard.

EP 0 802 693 A2 discloses a method for connecting base stations of radio-operated mobile parts according to the DECT standard to ISDN branch exchanges, in which method all features of the branch exchange are available to the mobile parts without restriction.

In this arrangement, the DECT-specific components of the system are integrated in the base stations and the base stations are connected to the branch exchange via two digital interfaces each of which has n B channels and n D channels.

The base stations from the branch exchange are synchronized via one of the D or B channels and the logical protocol is exchanged between branch exchange and base stations via the second one of the D or B channels.

The present invention has the purpose of not restricting the DECT method only to the traditional application of the cordless telephone but to use it for implementing the wireless extension of a telephone transmission link (“last mile” concept) or—even more generally—to apply it to a cellular mobile telephone system.

The disadvantage of the range of DECT, which is short compared with GSM, is compensated for by the lower transmitting power and, therefore, longer standby time of the mobile parts and the simpler and therefore more inexpensive construction of the base stations. In addition, the telephone lines which are already in existence are used as connection between switching centre and base station. The line cards in the switching centre are also completely hardware-compatible with ISDN line cards so that a large proportion of the existing infrastructure can be used.

In wireless local loop (WLL) systems—often also called radio in the loop (RITL) systems—the connections between subscriber and switching centre (LT) consist both of a point-to-multipoint radio link part between the radio base stations (BS) and the mobile parts and of a wire-connected part between LT and BS and are advantageously operated in the ISDN standard for reasons of the range as U interface.

Usually, the DECT standard is used for the radio part and the data compression/decompression (ADPCM) is already performed in the LT. It is then possible to transmit four DECT channels very effectively via the two B channels of the U interface.

In cellular wireless systems (CWS), one radio cell is allocated to each BS. The subscriber uses a mobile telephone, e.g. according to the DECT standard, by means of which he can reach all other subscribers within the cell area via the LT and, naturally, has access to the entire switching system. The radio cells can be in a local area (wireless PBX, e.g. on the terrain of a company) or also cover the area of an entire city so that mobile telephony is possible therein.

To achieve interference-free handover for a mobile subscriber between adjacent radio cells (roaming), ETSI (ETS 300 175-2) prescribes a maximum time offset between the DECT transmit frames of any two BSs with respect to one another of ±2.0 μs. It is not possible to achieve this without additional measures with an arbitrary line length due to the signal delay, which increases by approx. 5 μs per kilometer of line. Maintaining this time tolerance, is, therefore, achieved by the following measures:

the different delays on the U interfaces (due to line length, cross section and temperature) must be measured, transmitted to the BS and there compensated for (delay compensation).

since the LT represents the time reference and the clockmaster, all BSs are synchronized from here via the U interfaces.

the internal delays of the data through LT and BS are either constant for all channels or are included in the delay compensation, i.e. it must be possible to measure them.

the delays in generating and evaluating the synchronization signals are the same for all channels.

if the EOC (embedded operational channel in the superframe of U) channel is used for transmitting the synchronization signal to the BS, or superframes of U must be synchronized with one another in the LT.

The jitter of the BS transmit signal, caused by jitter in the switching system reference clock, in the LT and in the BS is small enough since its maximum value is included in the total tolerance.

If such a cellular mobile telephone network is to be extended over a relatively large area, it is necessary to operate the base stations from different line terminations (LT). So that a seamless transition of mobile subscribers between radio cells which are supplied via base stations (BS) which are connected to different line terminations (LT) is still possible, the synchronization of all line terminations (LT), even those which are located at different locations, must be ensured in such a manner that when spatially separate base stations (BS) are used, they are synchronous to one another in their timing. This synchronism can then be used to provide for an intercell handover so that a cordless, spatially large switching system can be set up on the basis of ISDN in the line-connected part.

In the prior art, the very elaborate synchronization of the systems located at different locations has hitherto only been achieved by means of the worldwide satellite navigation system GPS.

It is, therefore, the object of the present invention to create a device and a method for the cordless transmission of telephone calls via a number of spatially separate base stations in mobile telephones in a DECT standard, in which the base stations can also be connected to different, spatially separate line terminations. This is the only way in which to set up and operate a cellular mobile telephone network in the DECT standard which really covers a large area.

According to the invention, this object is achieved by the fact that the spatially separate base stations are connected to the telephone network via different line terminations which are also spatially separate and another line is connected between the line terminations for measuring the delay between the line terminations and for synchronization.

This is preferably an ISDN U line.

Furthermore, according to the invention a method is specified in which the transmission during the telephone calls can take place via a number of spatially separate base stations which are connected to the telephone network via different line terminations which are also spatially separate, the required synchronization taking place by means of an additional line between the line terminations for measuring the delay between the line terminations. Here, too, the additional line is preferably an ISDN U line.

In the text which follows, the invention is explained with reference to the exemplary embodiment shown in the attached drawings, in which:

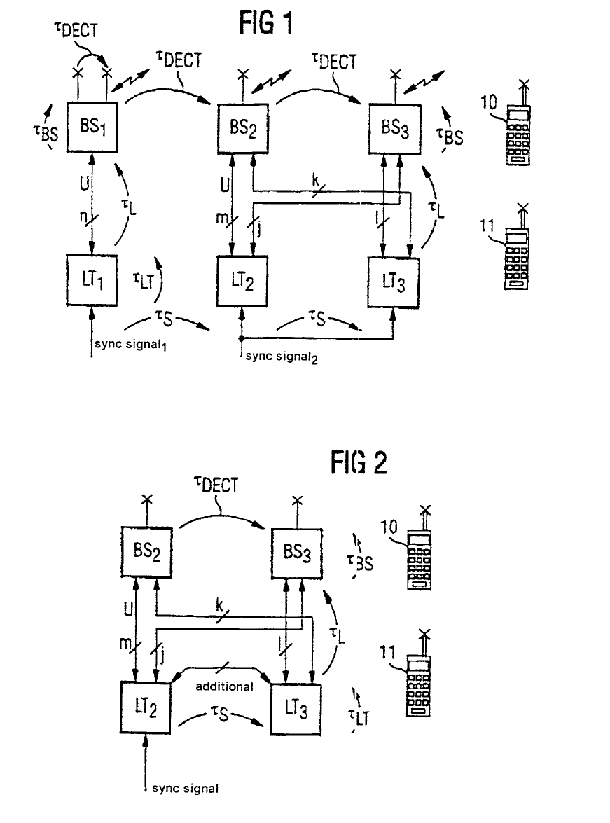

FIG. 1 shows a basic circuit diagram of a mobile telephone switching system;

FIG. 2 shows the line additionally to be inserted according to the invention;

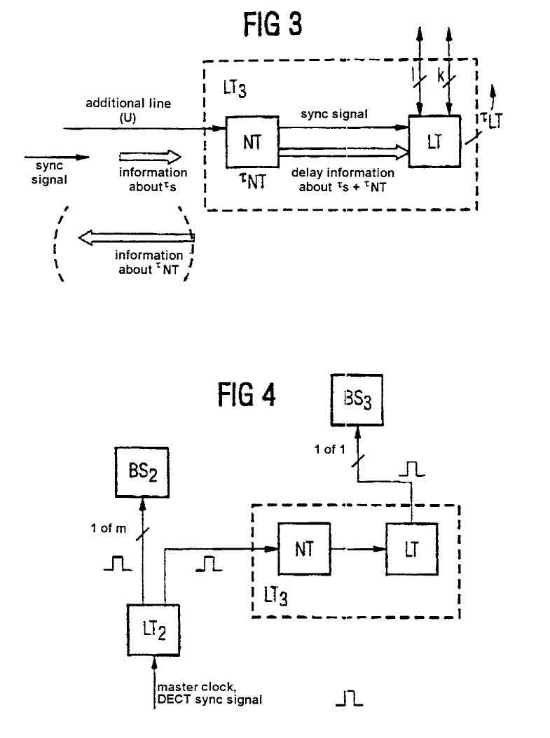

FIG. 3 shows the configuration according to the invention of a corresponding line termination in detail,

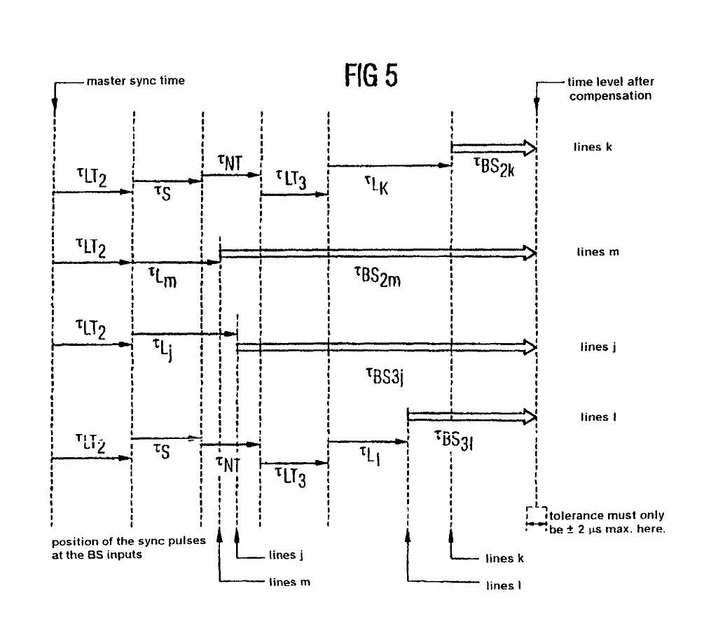

FIG. 4 shows the propagation of the clock and the direction of the synchronization in the mobile radio system shown diagrammatically, and

FIG. 5 shows a corresponding timing diagram.

The line terminations (=clockmaster) LT are connected via the U interfaces to base transmitting stations BS which, in turn, are connected to the DECT terminals 10, 11 via radio. A switching system receives a central synchronization signal and sends out the data on all U lines in synchronism therewith, delayed by a fixed delay τ_{LT} with respect to the synchronization signal. On U, the usual ISDN standard applies. Since all lines between LT and BS generally have different parameters (length, cross section, temperature etc.), their delays τ_{L} are individual so that the data initially sent out synchronously by the LT are no longer synchronous to one another at the BSs. They are, therefore, resynchronized in the base station by measuring the delays τ_{L} from the LT, transmitting them to the BS and applying to them an additional value τ_{BS} from the BS so that the following holds true for all n powers: τ_{LT}_{₁}+τ_{L}_{ₙ}+τ_{BS}_{ₙ}≈const ∀n.

This method is known as “delay compensation for DECT link” and is already in operation (e.g. implemented by means of Siemens chips DFEQ (PEM 24911) and IECQ (PEB 2091) and MBMC (PMB 2727)). In FIG. 1, LT₁ and BS₁ with the n lines are an independent system. BS is here drawn with 2 antennas in order to illustrate that, after the delay compensation, the remaining time difference τ_{DECT} (=time difference between cells) can be ideally compensated to become 0. In real values, the sum τ_{LT}_{₁}+τ_{L}_{ₙ}+τ_{BS}_{ₙ} has a tolerance so that T_{DECT}≠0, e.g. due to the fact that the TL values are not known accurately enough. A handover between the cells of a DECT system is possible if −2 μs<τ_{DECT}<+2 μs. This can be achieved without problems with an LT₁, BSₙ system.

Considering, however, a system of LT₁, LT₂, BS₁ and BS₂ with spatially separate LTs (and BSs), it is generally not possible to bring τ_{DECT} between BS₁ and BS₂ below ±2 μs since the sync signals 1 and 2 of LT₁ and LT₂ have an arbitrary time off set τ_{S} with respect to one another which is fully additively included in τ_{DECT}. Thus, either τ_{S} must be known or the synchronization signals must be synchronous with one another:

τ_{S} known; message for this→subject-matter of the present invention.

sync signals synchronous to one another→is achieved by means of GPS (expensive).

According to the invention, the τ_{S} is also measured with the aid of a method which, in principle, is the same as that for measuring τ_{L} so that all delays in the system LT₂, LT₃, BS₂, BS₃ can be synchronized with one another in BS₂ and BS₃ (“compensated for”) and an intercell handover (=change of the mobile subscriber between various radio cells) between cells of BS₂ and those of BS₃ thus becomes possible without problems. The total system has a common synchronization signal and an additional U line is connected between LT₂ and LT₃ as shown in FIG. 2.

The major advantage of the invention is the low level of effort (only one lchannel NT is necessary in LT₃) and the same method as already used in the LT₁, BS₁ system can also be used for measuring the delay.

Apart from the delays τ_{L} on lines m and j, LT₂ also measures the delay τ₃ on the line to LT₃. This delay information τ_{S} is transmitted to LT₃ (as in the transmission of LT→BS). Thus, the NT side in LT₃ is identical to the NT receiving side in the BSs.

All delays are then known in the system so that a compensation can be carried out in which the following holds true (e.g. in lines m and k):

τ_{Lm}+τ_{LT}_{₂}+τ_{BS1}_{ₘ}=τ_{LT}_{₂}+τ_{L}_{ₓ}+τ_{S}+τ_{NT}+τ_{LT3}+τES3_{ₓ}

The synchronization of LT₃, and that of BS₃, takes place by the synchronization of LT₂ being sent to LT₃ via the additional line. The delay difference between the synchronization of LT₂ and LT₃, however, is exactly τ_{S}+τ_{NT} and has already been taken into consideration in the compensation so that τ_{DECT} can be reduced ideally to zero and in real values to ±2 μs between all “antennas” of BS₂ and BS₃. After the synchronization, the jitter of the only “master sync signal” is also transmitted to LT₂ via the additional U line (which is why this line is continuously active) and is, therefore, equally included in all BSs (if the jitter frequency <<1/τ_{S}) and thus has no influence on τ_{DECT}. To illustrate this, FIG. 3 again shows how synchronization and propagation of the clock are carried out.

FIG. 4 again shows the principle of propagation of the clock and the direction of synchronization in a very simple mobile radio system shown diagrammatically. As shown in the top half of FIG. 4, this mobile radio system consists of a line termination LT₂ which is fed with the master clock and thus the DECT synchronization signal. A base station BS₂ is directly connected to the line termination LT₂ via the lines m. Furthermore, the line termination LT₂ is connected via an ISDN U line to a further line termination LT₃ which is connected to another base station BS₃ via the lines 1.

Furthermore, the corresponding timing is specified in FIG. 5, and here, too, lines k and j from the right-hand part of FIG. 1 are specified. It is assumed in this connection that base station BS2 is connected to the line termination LT3 via lines k and conversely line termination LT2 is connected to base station BS3 via lines j. The total time delays up to the transmission are obtained on the basis of the master sync time which in each case designates the common beginning of the time axes on the left-hand side, for example for the line m drawn above simply as time delays in the line termination LT₂ (T_{LT2}) plus time delays for lines m (T_{LM}). To achieve then a synchronous radiation of the signals by the base stations, a corresponding additional time delay τ_{BSm} must be introduced so that the sending out of the signal is delayed to such an extent that simultaneous sending out of the signals can also be implemented by other stations having longer delays. For this purpose, for example, lines 1 must be considered in which the signal is conducted from LT₂ via the link line to LT₃ and then to the base station BS₃. In this arrangement, the following time delays occur: τ_{LT2} in line termination LT₂, τ_{S} during the transmission via the line between line termination LT₂ and line termination LT₃, τ_{NT} and τ_{LT3} in line termination LT₃, τ_{L1} on the line path between line termination LT₃ and base station BS₃. Thus, only a time delay T_{BS31} must be added in order to achieve the simultaneous sending time. These additionally added time delays are always shown as double arrows on the time axis. The same applies to the signal paths via lines k and j of FIG. 1, also shown.

What is claimed is:

1. A device comprising:
a number of spatially-separate base stations for the cordless transmission of telephone calls or other ISDN B-channel to mobile telephones in the DECT standard;
wherein said spatially-separate base stations are configured to be connected to the telephone network via different line terminations which are also spatially separate from each other, in which arrangement an additional line is configured to be connected between the line terminations for measuring delay between the line terminations and for synchronization.

2. The device according to claim 1, wherein said additional line is an ISDN U line.

3. A method for cordless transmission of telephone calls via a number of spatially separate base stations to mobile telephones in the DECT standard, comprising:
during the telephone calls, transmitting via a number of spatially-separate base stations which are connected to the telephone network via different line terminations which are also spatially separate; and
synchronizing via an additional line between the line terminations for measuring delay between the line terminations.

4. The method according to claim 3, wherein an ISDN U line is used as an additional line.
